(19) United States
(12) Patent Application Publication
(10) Pub. No.: US 2012/0235874 A1
(43) Pub. Date: Sep. 20, 2012

(54) DEPLOYABLE REFLECTARRAY ANTENNA

(75) Inventors: ChangSoo KWAK, Daejeon (KR); Man Seok UHM, Daejeon (KR); Jang-sup CHOI, Daejeon (KR); So-hyeun YUN, Daejeon (KR); In Bok YOM, Daejeon (KR); Hongyeol LEE, Chungcheongbuk-do (KR)

(73) Assignee: Electronics and Telecommunications Research Institute, Daejeon (KR)

(21) Appl. No.: 13/414,012

(22) Filed: Mar. 7, 2012

(30) Foreign Application Priority Data
Mar. 14, 2011 (KR) 10-2011-0022511

(51) Int. Cl. H01Q 19/185

(52) U.S. Cl. 343/837

(57) ABSTRACT

A deployable reflectarray antenna includes a plurality of reflectarray antenna panels each having one edge connected to be folded and unfolded. Each reflectarray antenna panel includes a membrane having reflecting elements and a support frame. The support frame includes outer frames surrounding edges of the membrane, and a plurality of reinforcing members disposed in a vertical direction between the outer frames in a length direction.

### CROSS-REFERENCE TO RELATED APPLICATION

This application claims priority to and the benefit of Korean Patent Application No. 10-2011-0022511 filed in the Korean Intellectual Property Office on Mar. 14, 2011, the entire contents of which are incorporated herein by reference.

### BACKGROUND OF THE INVENTION

(a) Field of the Invention

The present invention relates a deployable reflectarray antenna.

(b) Description of the Related Art

In order to locate a large space antenna in a desired orbit, the large space antenna is folded and loaded into a projectile. After locating the folded antenna in the desired orbit, the antenna is unfolded to its desired size and shape. Such an antenna may be referred to as a deployable antenna. An antenna including a truss, a cable, and a mesh has been used widely as the deployable antenna. The truss supports a basic structure of an antenna. The cable forms a structure for a reflection surface. For example, the cable may form a parabolic structure. A conductive mesh is disposed on the cable so as to form an electrical reflection surface. As described above, a typical deployable reflect antenna may include the truss, the cable, and the conductive mesh.

In addition to the above-described deployable reflect antenna, a membrane reflectarray antenna has been introduced. The membrane reflectarray antenna is light in weight and forms a reflecting flat surface so as to improve a degree of precision. The membrane reflectarray antenna includes reflecting elements arranged at a curved membrane surface or a flat membrane surface. Typically, a microstrip path has been used as the reflecting element. When the reflecting elements reflect electromagnetic waves entering the reflecting elements, the phase of the electromagnetic waves is changed according to the shape and size of the reflecting element. The membrane reflectarray antenna uses such characteristics of the reflecting elements to form a desired radiating pattern. The reflecting elements may be disposed on one side of the membrane, and form a dielectric material layer. A ground side may be formed on the other side of the membrane. Since the membrane is thin, the membrane is weak against bending stress and twisting stress. Accordingly, it is very difficult to maintain the membrane to be planar.

### SUMMARY OF THE INVENTION

The present invention has been made in an effort to provide a deployable reflectarray antenna having advantages of having a light weight and preventing bending and twisting.

An exemplary embodiment of the present invention provides a deployable reflectarray antenna. The deployable reflectarray antenna includes a plurality of reflectarray antenna panels, each configured to have one edge connected to an adjacent reflectarray antenna panel so as to form a pair with the adjacent reflectarray antenna, and to be folded with the adjacent reflectarray antenna panel while having a front surface facing a front surface of the adjacent reflectarray antenna panel. Each of the plurality of reflectarray antenna panels includes a membrane, reflecting elements arranged on a front side of the membrane, and a support frame for supporting the membrane.

The support frame may include outer frames surrounding edges of the membrane, and a plurality of reinforcing members formed in a vertical direction between the outer frames in a length direction.

The support frame may further include a back shear panel for supporting the membrane at a side opposite to the front side of the membrane.

The outer frame may be formed integrally with the back shear panel.

The back shear panel may be made of the same material as the membrane.

Another exemplary embodiment of the present invention provides a deployable reflectarray antenna. The deployable reflectarray antenna may include a reflectarray antenna formed by arranging reflecting elements on a membrane and a support frame for supporting the membrane. The support frame may include outer frames surrounding edges of the membrane and a plurality of reinforcing members disposed in a vertical direction between the outer frames of a length direction. The reflectarray antenna and the support frame may form a reflectarray antenna panel. The reflectarray antenna panel may be connected to an adjacent reflectarray antenna panel as a pair, and the reflectarray antenna panel may be folded to have a front surface facing a front surface of the adjacent reflectarray antenna panel.

### BRIEF DESCRIPTION OF THE DRAWINGS

FIG. 1 illustrates a reflectarray antenna in a folded state in accordance with an exemplary embodiment of the present invention.

FIG. 2 illustrate a reflectarray antenna in an unfolded state in accordance with an exemplary embodiment of the present invention.

FIG. 3 is a cross-sectional view of a reflectarray antenna panel in accordance with an exemplary embodiment of the present invention.

FIG. 4 illustrates a membrane having a reflectarray antenna of FIG. 3.

FIG. 5 is an enlarged view of a part A in FIG. 4.

FIG. 6 illustrates a support frame of FIG. 3.

FIG. 7 and FIG. 8 illustrate bending and twisting of a support frame in accordance with an exemplary embodiment of the present invention.

FIG. 9 is a cross-sectional view of a reflectarray antenna panel in accordance with another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Hereinafter, a deployable reflectarray antenna in accordance with an exemplary embodiment of the present invention will be described with reference to the accompanying drawings.

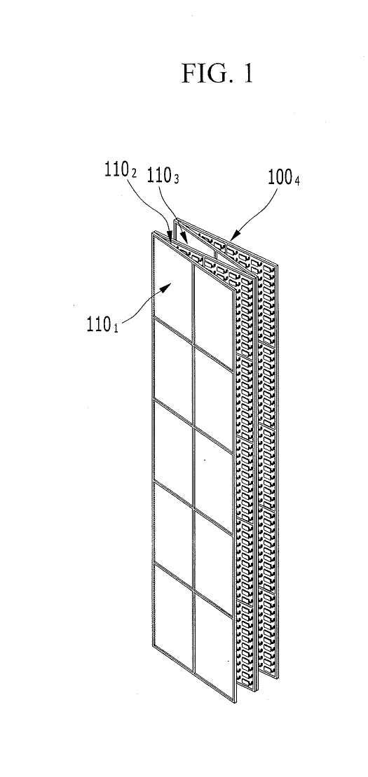

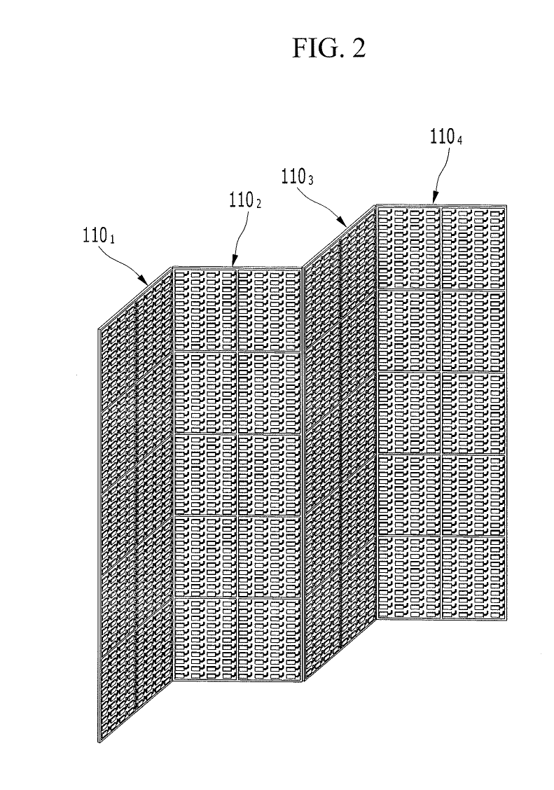

FIG. 1 illustrates a deployable reflectarray antenna in a folded state in accordance with an exemplary embodiment of the present invention, and FIG. 2 illustrates a deployable reflectarray antenna in an unfolded state in accordance with an exemplary embodiment of the present invention.

Referring to FIG. 1 and FIG. 2, a deployable reflectarray antenna may include a plurality of reflectarray antenna panels 110₁ to 110_{N}. In FIG. 1 and FIG. 2, it is assumed that N is 4.

The reflectarray antenna panels 110₁ to 110_{N} are connected to each other through a hinge unit (not shown) disposed at a vertical axis. Two adjacent reflectarray antenna panels 110₁ to 110_{N} may form a pair and may be folded together to have front surfaces facing each other. All the reflectarray antenna panels 110₁ to 110_{N} may be unfolded to form a flat surface or may be unfolded to form a predetermined angle between two adjacent reflectarray antenna panels 110₁ to 110_{N}.

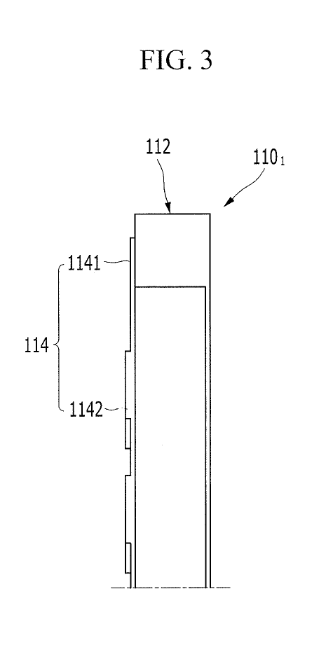

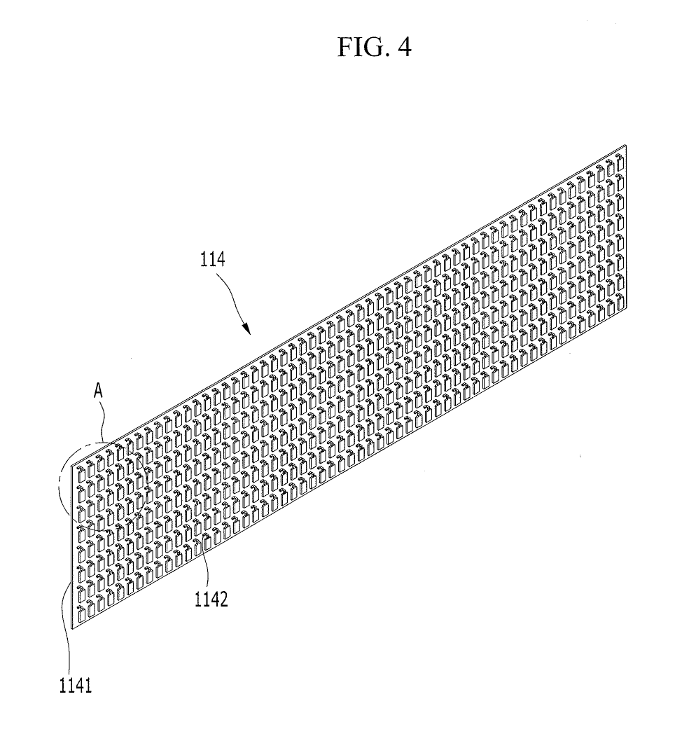

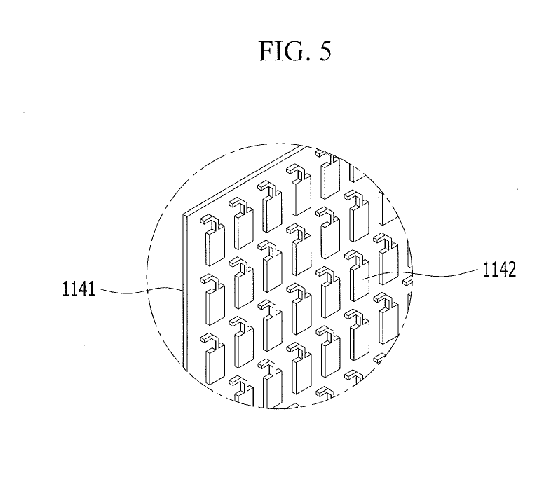

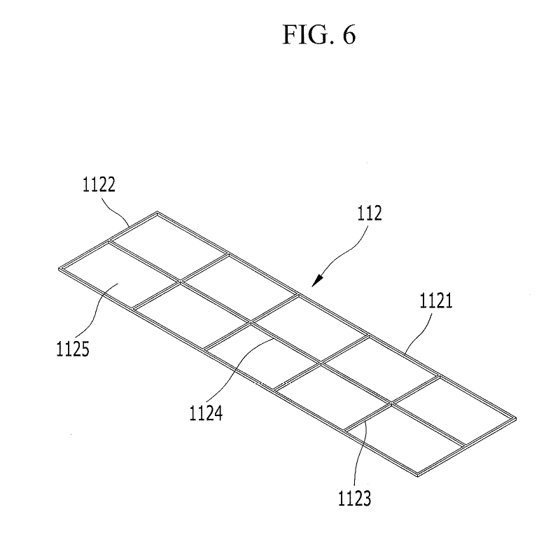

FIG. 3 is a cross-sectional view of a reflectarray antenna panel in accordance with an exemplary embodiment of the present invention, and FIG. 4 illustrates a reflectarray antenna having a membrane shown in FIG. 3. FIG. 5 is an enlarged view of a part A in FIG. 4. FIG. 6 illustrates a support frame of FIG. 3.

Referring to FIG. 3, each of the reflectarray antenna panels 110₁ to 110_{N} may include a support frame 112 and a reflectarray antenna 114. Although FIG. 3 illustrates only a first reflectarray antenna panel 110₁ among the antenna panels 110₁ to 110_{N}, other reflectarray antenna panels 110₂ to 110_{N} have the same configuration as the first reflectarray antenna panel 110₁.

Referring to FIG. 4 and FIG. 5, the reflectarray antenna 114 may include a membrane 1141 and a reflecting element 1142.

The membrane 1141 may be a dielectric substance, may be made of a thin layer material, and does not have a bending strength.

A plurality of reflecting elements 1142 may be arranged on one side of the membrane 1141 with a predetermined gap therebetween, and a ground side may be formed on the other side of the membrane 1141. The membrane 1141 and the plurality of reflecting elements 1142 may form the reflectarray antenna 114. Since the reflectarray antenna 114 is formed using the membrane 1141, a lightweight reflecting surface can be formed. Accordingly, the weight of the reflectarray antenna 114 can be reduced.

A bias and a phase of electromagnetic waves reflected by the reflecting element 1142 may be changed according to the shape of the reflecting element 1142. Accordingly, the reflecting element 1142 may have different shapes and different sizes according to a required condition of an antenna. For example, the reflecting element 1142 may be formed in a microstrip shape.

Referring to FIG. 3 again, the membrane 1141 having the reflecting elements 1142 may be attached to the support frame 112. The support frame 112 may have one side to which the membrane 1141 is attached and the other side to which a thin member is attached. A side opposite to the front side of the membrane is covered by the thin member. The thin member may be made of the same material as the membrane 1141 or of a material having high shear strength. The thin member may be integrally formed with the support frame 112. As described above, the support frame 112 may significantly reduce twisting of the entire structure.

The membrane 1141 may be winkled unless tension is applied in all directions, so it may be attached to the support frame 112 while applying proper tension in all directions. Accordingly, the membrane 1141 may be made of a material having a high elastic property.

Referring to FIG. 6, the support frame 112 may be formed with a very thin flat structure. The support frame 112 may include outer frames 1121 and 1122 extending in a length direction and a width direction, respectively, and at least one vertical bar 1123 and horizontal bar 1124. The at least one vertical bar 1123 and horizontal bar 1124 may be disposed between the respective outer frames 1121 and 1122 at regular intervals. The support frame 112 may further include a back shear panel 1125. Alternatively, the back side of the membrane 1141 may function as the back shear panel 1125.

The outer frames 1121 and 1122 of the support frame 112 may extend along the edges of the membrane 1141 and have a predetermined thickness. The thickness of the support frame 112 may be about 2% of the longest length of the support frame 112. The length direction of the outer frames 1121 may be prone to bending because the outer frame 1121 is longer than the width direction outer frame 1122. Accordingly, a plurality of vertical bars 1123 may be disposed between the length-direction outer frames 1121 in a vertical direction at regular intervals. The plurality of vertical bars 1123 may improve structural strength.

In accordance with an embodiment of the present invention, the support frame 112 is not formed as one flat structure with a predetermined thickness. The support frame 112 may be formed as a minimal frame using enforcement members, such as the outer frames 1121 and 1122, the vertical bars 1123, and the horizontal bar 1124. For example, the support frame 112 may have empty spaces that are delineated by the outer frames 1121 and 1122, the vertical bars 1123, and the horizontal bar 1124 as shown in FIG. 6. Accordingly, the support frame 112 has a smaller weight than a support frame formed as a flat structure with a predetermined thickness while improving strength per unit weight.

Such a support frame 112 may be formed of a typical carbon fiber-reinforced composite material.

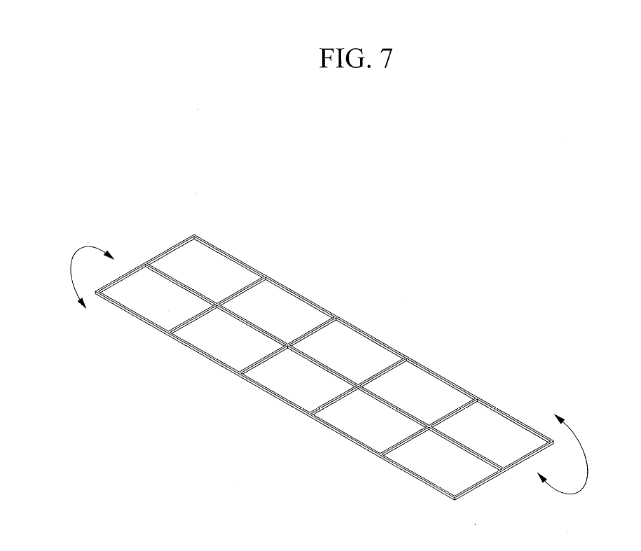

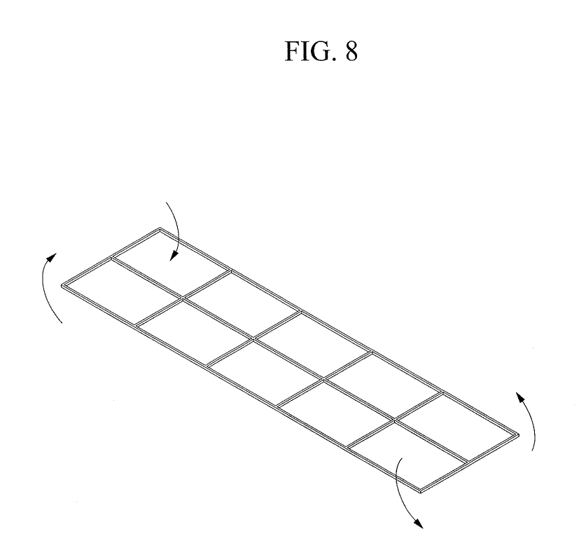

FIG. 7 and FIG. 8 illustrate bending and twisting of a support frame in accordance with an exemplary embodiment of the present invention.

Referring to FIG. 7 and FIG. 8, the support frame 112 may be bended and/or twisted, which are typical deformation modes.

In accordance with an exemplary embodiment of the present invention, bending may be prevented by increasing thicknesses of the outer frames 1121 and 1122, the vertical bars 1123, and the horizontal bar 1124 and forming empty spaces using the same. In this manner, strength per unit weight can be improved.

That is, the thicknesses of the outer frames 1121 and 1122, the vertical bars 1123, and the horizontal bar 1124 may be formed thicker than the back shear panel 1125. Accordingly, the support frame 112 may have internal empty spaces delineated by the outer frames 1121 and 1122, the vertical bars 1123, and the horizontal bar 1124. The outer frames 1121 and 1122 may have a predetermined thickness that can prevent the outer frames 1121 and 1122 from bending.

A structure is easily twisted when one side thereof is open. In accordance with an embodiment of the present invention, the membrane 1141 may close one side of the support frame 112. Accordingly, the support frame 112 may not be easily twisted.

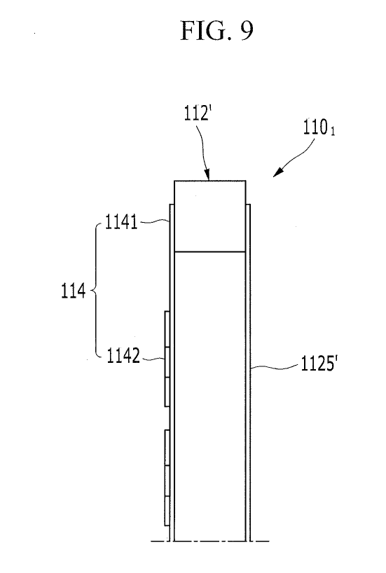

FIG. 9 is a cross-sectional view of a deployable reflectarray antenna in accordance with another exemplary embodiment of the present invention.

Referring to FIG. 9, a membrane 1141 may be formed on one side of a support frame 112′ and a back shear panel 1125′ may be formed on the other side. Particularly, a skin part of the back shear panel 1125′ extends along the other side of the support frame 112′. As described above, the back shear panel 1125 may be a thin member made of the same material as the membrane 1141 or made of a material having high shear strength.

According to an exemplary embodiment of the present invention, the support frame supporting the reflectarray antenna is formed with minimal frames. Accordingly, the deployable reflect antenna can be prevented from bending and twisting while having a light weight.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A deployable reflectarray antenna comprising
a plurality of reflectarray antenna panels, each configured to have one edge connected to an adjacent reflectarray antenna panel so as to form a pair with the adjacent reflectarray antenna panel and to be folded with the adjacent reflectarray antenna panel while having a front surface facing a front surface of the adjacent reflectarray antenna panel,
wherein each of the plurality of reflectarray antenna panels includes:
a membrane;
reflecting elements arranged on a front side of the membrane; and
a support frame configured to support the membrane.

2. The deployable reflectarray antenna of claim 1, wherein the support frame includes outer frames surrounding edges of the membrane, and
a plurality of reinforcing members formed in a vertical direction between the outer frames in a length direction.

3. The deployable reflectarray antenna of claim 2, wherein the support frame further includes a back shear panel for supporting the membrane at a side opposite to the front side of the membrane.

4. The deployable reflectarray antenna of claim 3, wherein the outer frame is formed integrally with the back shear panel.

5. The deployable reflectarray antenna of claim 3, wherein the back shear panel is made of the same material as the membrane.

6. The deployable reflectarray antenna of claim 1, wherein the reflecting element is formed in a microstrip shape.

7. A deployable reflectarray antenna comprising:
a reflectarray antenna formed by arranging reflecting elements on a membrane; and
a support frame configured to include outer frames surrounding edges of the membrane and a plurality of reinforcing members disposed in a vertical direction between the outer frames in a length direction, and to support the membrane having the reflecting elements,
wherein the reflectarray antenna and the support frame form a reflectarray antenna panel, the reflectarray antenna panel is connected to an adjacent reflectarray antenna panel as a pair, and the reflectarray antenna panel is folded to have a front surface facing a front surface of the adjacent reflectarray antenna panel.

8. The deployable reflectarray antenna of claim 7, wherein the support frame further includes a back shear panel disposed at the back side of the membrane, and the thickness of the outer frame is greater than the thickness of the back shear panel.
